(19) United States
(12) Patent Application Publication
(10) Pub. No.: US 2008/0289527 A1
(43) Pub. Date: Nov. 27, 2008

(54) Device and Method for Correcting Lateral Position of a Printing Substrate

(75) Inventors: Michael Pasuch, Walldorf (DE); Bernd Hoffmann, Schifferstadt (DE); Hendrik Frank, Erkelenz (DE); Matthias Noll, Weiterstadt (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/122,973

(22) Filed: May 19, 2008

(30) Foreign Application Priority Data
May 18, 2007 (DE) 10 2007 023 415.7

(51) Int. Cl. B41F 21/14

(52) U.S. Cl. 101/474; 101/485

(57) ABSTRACT

A device for correcting the lateral position of a printing substrate, preferably a sheet of paper, held by a gripper bar and conveyed in a transporting direction has a linear drive that includes a first primary part and a first secondary part configured as a first carriage and associated with the first primary part, and a second secondary part configured as a second carriage. The first carriage and the second carriage are arranged on the same side of the printing substrate in the lateral direction and—to correct the position of the printing substrate in the lateral direction—are movable relative to each other in the direction of transport. Such a device may be used for transporting printing substrates and for correcting the register position of printing substrates in machines for processing printing substrates, preferably printing presses or machines for the further processing of printed products. The relative movement of the two carriages with respect to each other initiates a lateral movement of the gripper bar without influencing the advancement of the printing substrate.

### CROSS-REFERENCE TO RELATED APPLICATION

This application claims the priority, under 35 U.S.C. § 119, of German application DE 10 2007 023 415.7, filed May 18, 2007; the prior application is herewith incorporated by reference in its entirety.

### BACKGROUND OF THE INVENTION

### Field of the Invention

The present invention relates to a device for correcting the lateral position of a printing substrate held by a gripper bar, a printing substrate-processing machine with the device, and also to a method of correcting the lateral position of a printing substrate as it is being conveyed in a given transport direction.

In the field of the graphic arts industry, it is known from the prior art to convey and process a printing substrate in machines that process a printing substrate, such as printing presses, in a way to ensure register accuracy. Even as it is being fed to the machine, a printing substrate may be aligned to be in register. In addition, register corrections during transport through the machine are possible. Register correction may refer to the register in the direction of travel, also known as the circumferential register, to the register in the lateral direction (lateral relative to the direction of travel), also known as the lateral register, and to the register of a skewed printing substrate, also known as the diagonal register. For the purpose of register alignment and register correction, pulling marks and lateral stops are provided in the region of printing substrate feeders. It is also known from the prior art to provide cylinders for guiding printing substrates that are adjustable or at least include adjustable components.

Moreover, it has become known heretofore in the graphic arts industry to use electric linear drives that usually have a primary part and respective secondary parts (carriages) associated with the respective primary part on each side of the printing substrate to transport a printing substrate through the machine instead of using cylinders for guiding the printing substrate through the machine. In such a linear drive system, a crossbar or gripper bar is usually provided between two opposing carriages to grip the printing substrate and transport it through the processing machine. A device of that type for a printing press is described in commonly assigned German patent DE 197 48 870 C2 (see, U.S. Pat. No. 6,044,760). German published patent application DE 100 20 324 A1 (see, U.S. Pat. No. 6,876,896 B1) describes the use of a linear drive in a packaging machine.

Commonly assigned German published patent application DE 10 2006 057 506 (see, US 2007/0145667 A1) also describes a linear drive for transporting printing substrates. Register correction is initiated by a relative movement of two carriages. The two carriages are arranged laterally and are located on different sides of the printing substrate. Simultaneous adjustment (with or without closed-loop control) of lateral register and diagonal register is not possible. Furthermore, JP 2003-159679 A describes a double-axle robot that has a first linear drive and a second linear drive and a crossbar. The first linear drive is arranged laterally and is used to advance the crossbar, whereas the second linear drive, which is arranged laterally and opposite the first lateral linear drive, is used to advance an adjustment element, which is connected via a link to an element that is movable on the crossbar. Thus the position of the crossbar in the direction of transport can be adjusted by means of the first linear drive, and the lateral position of the element received on the crossbar can be adjusted by means of the second linear drive. However, the use of the described robot for transporting a printing substrate through machines that process a printing substrate is not disclosed.

### BRIEF SUMMARY OF THE INVENTION

It is accordingly an object of the invention to provide a device that allows a correction of the position of a printing substrate in the lateral direction and which overcomes the above-mentioned disadvantages of the heretofore-known devices and methods of this general type.

It is a further or alternative object of the present invention to provide a device that allows such a correction and at the same time provides an improved way of transporting a printing substrate through the machine for processing a printing substrate in comparison to the known ways of the prior art.

It is a further or alternative object of the present invention to provide an improved device that allows simultaneous corrections of different registers (circumferential register, lateral register, and/or diagonal register). It is a further or alternative object of the present invention to provide a device that is improved over the prior art and does not require much installation space.

With the foregoing and other objects in view there is provided, in accordance with the invention, a device for correcting a lateral position of a printing substrate held by a gripper bar and conveyed in a transport direction, the device comprising:

an electric linear drive having a primary part, a first secondary part configured as a first carriage and associated with the primary part, and a second secondary part configured as a second carriage;

the first carriage and the second carriage being commonly disposed on a same side of the printing substrate in a lateral direction; and

the first carriage and the second carriage being movable relative to one another in the transport direction to correct a position of the printing substrate in the lateral direction.

It is likewise an object of the present invention to provide a method of correcting the position of a printing substrate in the lateral direction and in particular of transporting the printing substrate through a machine for processing a printing substrate in a way that is improved over the prior art.

It is a further or alternative object of the present invention to provide an improved method of simultaneously correcting different registers (circumferential register, lateral register, and/or diagonal register).

In accordance with the invention, a device for correcting the lateral position of a printing substrate that is held by a gripper bar and conveyed in a direction of transport (in other words: for correcting the position in the lateral direction), comprises an electric linear drive that includes a first primary part and a first secondary part associated with the first primary part and designed as a first carriage and a second secondary part designed as a second carriage, the first carriage and the second carriage being arranged on the same side of the printing substrate in the lateral direction and being movable relative to each other in the direction of transport to correct the position of the printing substrate in the lateral direction.

Thus in accordance with the invention, such a device includes two carriages that are on the same side of the printing substrate in the lateral direction rather than, as it is known from the prior art, on different sides of the printing substrate. Moreover, in accordance with the invention, the two carriages are movable relative to each other in the direction of transport, and a relative movement of the carriages causes a correction of the position of the printing substrate in the lateral direction, that is to say that the movement of the two carriages relative to each other is translated into or causes a lateral correcting movement of the printing substrate. Thus in contrast to the prior art, both for advancing the gripper bar and thus the printing substrate and for correcting the lateral position of the gripper bar and thus of the printing substrate, two carriages are available that are arranged on the same side of the printing substrate in the lateral direction. These two carriages may be supplemented by two more carriages that are likewise movable relative to each other and are located on the other side of the printing substrate and can likewise be used for advancing the printing substrate as well as for lateral position correction. By providing two carriages on one side of the printing substrate in accordance with the invention, both the correction of the lateral position of the printing substrate and the advancement of the printing substrate can be carried out by respectively just one of the carriages or jointly by both of the carriages. This feature results in a plurality of possible ways of controlling the advancement and the positioning of a printing substrate. A relative movement of the two carriages with respect to each other may initiate a lateral movement of the gripper bar without impairing the advancement of the printing substrate.

A further advantage of the present invention is that a simultaneous correction of different registers (circumferential register, lateral register, and/or diagonal register) is made possible. A relative movement between the two carriages can be carried out to adjust the lateral register (with or without closed-loop control), and at the same time a joint movement of the two carriages or carriage pairs in or against the direction of transport can be carried out to adjust the circumferential register (with or without closed-loop control). In addition, a relative movement of the two carriage pairs with respect to each other can be carried out to adjust the diagonal register (with or without closed-loop control).

In accordance with a further development of the invention that is advantageous in terms of its simple mechanical implementation and is consequently preferred, the first carriage and the second carriage may be mechanically coupled to each other by a link. The two carriages (on one and the same side of the printing substrate) thus form a mechanical unit, a fact that means that, at least in sections, advantageously only one carriage may be driven, whereas the other one of the two carriages may, likewise at least in sections, not be driven and still entrained or dragged along. The mechanical link between the two carriages may preferably be a pair of parallel rockers. If they are provided, the two carriages on the other side of the printing substrate may likewise be mechanically coupled to each other, preferably likewise by a pair of parallel rockers.

To be able to make use of the advantages that the two carriages can be moved relative to each other and that any one of the two carriages may not be driven, the first and the second carriage may be designed to be controllable or actuatable separately from each other. A common control or two separate controls may be provided for separately controlling the two carriages of the linear drive and thus for separately moving the carriages, i.e. for moving the carriages relative to each other—if a mechanical link is provided, within the limits defined by the link.

In accordance with a further preferred feature of the invention, the device has a first mode of operation in which the first carriage and the second carriage jointly effect the advancement of the gripper bar and thus the transport of the printing substrate. In accordance with another preferred feature of the invention, the device has a second mode of operation, in particular a supplementary mode of operation, in which only the first carriage or only the second carriage effects the advancement of the gripper bar and thus the transport of the printing substrate. This second mode of operation will be referred to as the “drag mode” in the following. In this context, a distinction is to be drawn between the passive drag mode and the active drag mode. In the passive drag mode, the two carriages are essentially not accelerated or decelerated, so that one carriage is dragged along by another carriage without being driven itself. The relative position of the two carriages does not change. In the active drag mode, the two carriages are accelerated or decelerated and thus actively participate in the driving dynamics (for example in the region of a sheet feeder in which the gripper bar initially needs to be decelerated and then accelerated to receive a sheet). Again, the relative position of the carriages does not change. A simplified way of providing regions along the transport path in which only the passive drag mode occurs may advantageously consist of not providing powered windings and inverters (on a primary part). A carriage that is being dragged may be secured and protected against falling down due to the magnetic attraction between its permanent magnet and the iron cores of the associated primary part.

In accordance with a further preferred feature of the invention the electric linear drive comprises a second primary part in addition to the first primary part, and the second carriage is associated with the second primary part, whereas the first carriage remains associated with the first primary part as described above. The electric linear drive (on one side of the printing substrate) thus includes two primary parts and two secondary parts or carriages. In addition, a further electric linear drive (on the other side of the printing substrate) may likewise include two primary parts and two secondary parts or carriages. In the following, the term “linear drive system” (short: system) is to be understood to jointly refer to the linear drive on the one side and to the linear drive on the other side of the printing substrate.

The scope of the invention also encompasses a machine for processing printing substrates, in particular a printing press—preferably a sheet-fed rotary printing press for lithographic offset printing—or a machine for the further processing of printed products—preferably a diecutting machine—that is distinguished by at least one device as described above with reference to the invention or by a device or system for correcting the lateral position of the printing substrate.

With the above and other objects in view there is also provided, in accordance with the invention, a method of correcting a lateral position of a printing substrate being conveyed in a transport direction, which comprises:

providing an electric linear drive with two carriages commonly arranged on a common side of the printing substrate in a lateral direction relative to the transport direction; and

carrying out a relative movement between the two carriages of the electric linear drive for correcting the lateral position of the printing substrate.

In other words, in accordance with the invention, a method of correcting the lateral position of a printing substrate (in other words: correcting the position in the lateral direction) that is being transported in a direction of transport comprises the step of implementing a relative movement between two carriages of an electric linear drive, the two carriages being arranged on the same side of the printing substrate in the lateral direction. The advantages of an implementation of the method of the invention are the same as those described above in terms of the device of the invention.

Other features which are considered as characteristic for the invention are set forth in the appended claims.

Although the invention is illustrated and described herein as embodied in device for correcting the lateral position of a printing substrate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic representation of a preferred exemplary embodiment of a device according to the invention.

FIG. 2 is a perspective view of a preferred exemplary embodiment of a device according to the invention.

FIG. 3 is a diagrammatic representation of a preferred embodiment of two mechanically coupled carriages in accordance with a device of the invention.

FIGS. 4A-4F are diagrammatic representations of a preferred exemplary embodiment of a linear drive system in accordance with the invention.

FIG. 5 is a diagrammatic representation of the different printing substrate correction options that can be implemented by moving the carriages of a device according to the invention.

FIG. 6 is a diagrammatic representation of possible modes of operation in selected sections of a preferred exemplary embodiment of a linear drive system according to the invention.

### DETAILED DESCRIPTION OF THE INVENTION

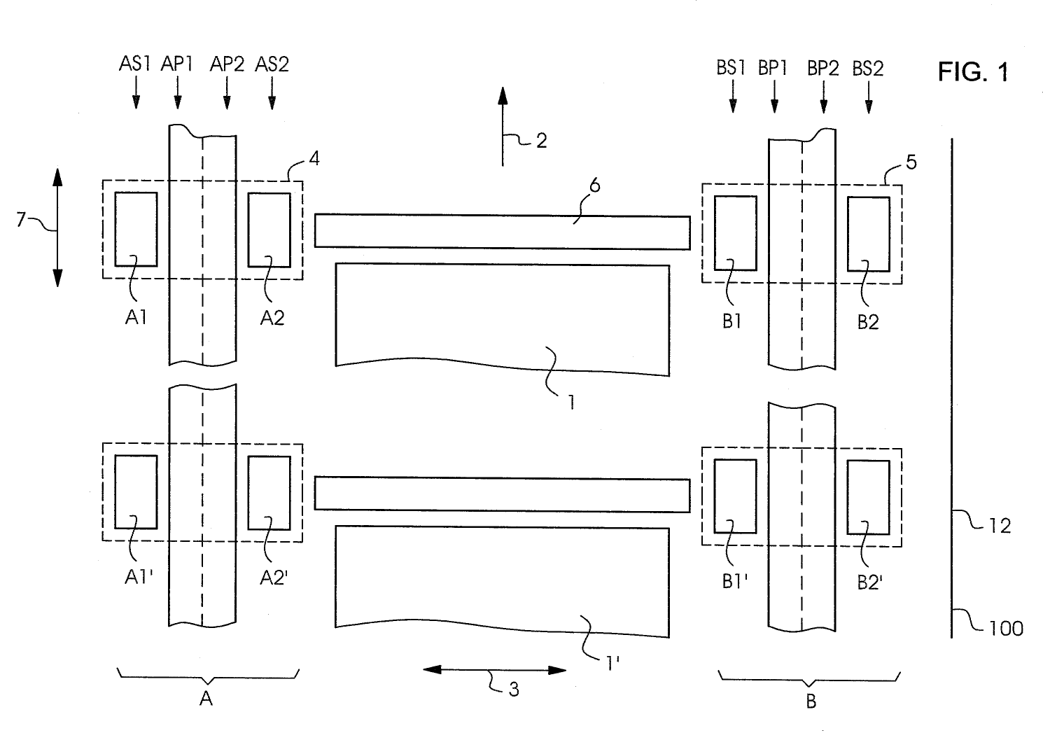

Referring now to the figures of the drawing in detail and first, particularly, to FIG. 1 thereof, there is illustrated a first linear drive A arranged laterally relative to a printing substrate 1, i.e. in the lateral direction relative to the direction of transport 2 of the printing substrate 1 and preferably in the plane of the printing substrate 1. The first linear drive A preferably has two primary parts and at least two secondary parts. The first primary part AP1 and the second primary part AP2 extend along the transport path of the printing substrate 1 through a machine 100 for processing printing substrates. Only a side wall is shown of the machine 100. The primary parts AP1, AP2 are designed in accordance with the single-comb principle. The two secondary parts AS1 and AS2 are designed as carriages A1 and A2, that is to say as runners of the linear drive A. Each of them includes a permanent magnet that is movable along a guide rail of the linear drive by appropriately switching the windings in the linear drive A. The first linear drive A may furthermore include a number of further carriage pairs A1′, A2′, A1″ and A2″ and so forth for advancing further printing substrates 1′, 1″ etc.

On the other side of the printing substrate, the linear drive system illustrated in FIG. 1 includes a second linear drive B, which, in a manner corresponding to the first linear drive A, includes a first primary part BP1, a second primary part BP2, a first secondary part BS1, a second secondary part BS2 (corresponding to a first carriage B1 and a second carriage B2) and, if desired, further carriages B1′, B2′, B1″, B2″ etc. Alternatively, a single carriage (with or without linear drive), dragged along by the carriage pair 4, or a cantilever bearing for the gripper bar 6 may be provided on the other side of the printing substrate.

The two carriages A1 and A2 of the first electric linear drive A form a carriage pair 4, which, together with a carriage pair 5 of the second electric linear drive B, effects the advancement of the gripper bar 6 and thus of the printing substrate 1 held and transported by the gripper bar 6. The further carriages of the linear drives A, B likewise form carriage pairs that are coupled to each other mechanically by a gripper bar and effect the advancement of a printing substrate.

As further illustrated in FIG. 1, the two carriages A1 and A2 of the carriage pair 4 are capable of carrying out a relative movement 7 with respect to each other in the direction of movement 2. The implementation of such a relative movement, which in particular effects a correction of the lateral position of the printing substrate 1 that is under the influence of the carriages, will be explained below with reference to the further figures.

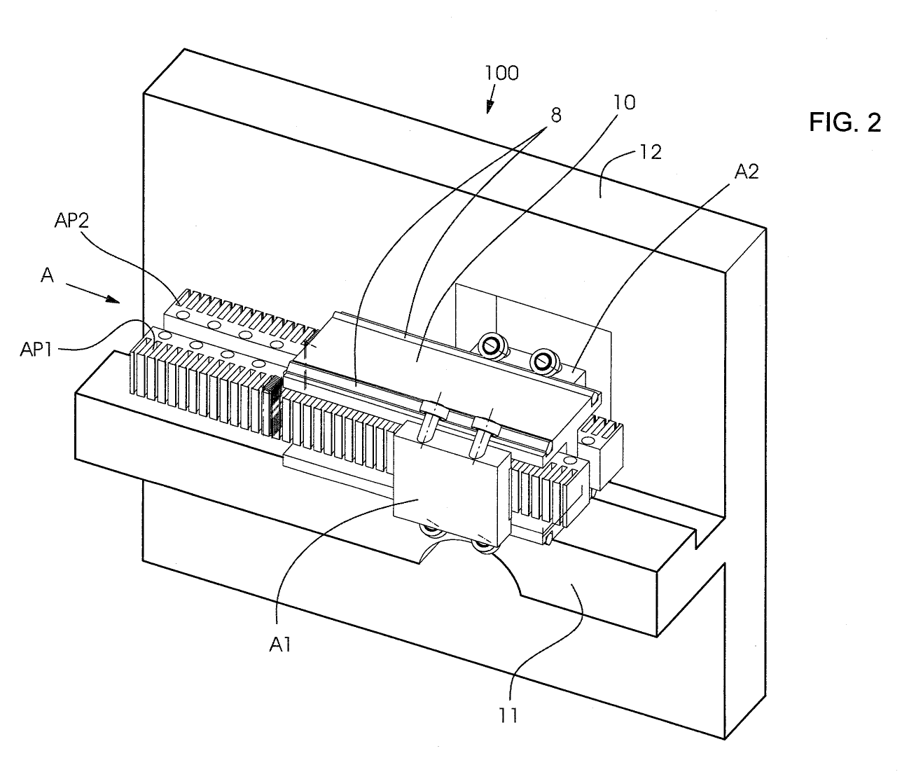

The diagrammatic representation of FIG. 2 illustrates a linear drive A including a first primary part AP1 and a second primary part AP2 and a first carriage A1 and a second carriage A2. The two carriages A1 and A2 are arranged opposite each other and run in particular on guides or guide rails of the linear drive A by means of rollers. Each of the two carriages A1 and A2 can be moved separately along the linear drive A by the associated primary parts AP1, AP2. Yet due to the mechanical link between the two carriages A1 and A2 as illustrated in the further figures, this relative movement is limited. In addition, the mechanical link may advantageously cause the two carriages to rest against the associated guides 8 even if the primary parts associated with the carriages temporarily do not provide any electromagnetically imparted pressing force. The perspective view of FIG. 2 only illustrates a section of the linear drive A as it may, for example, be provided on the drive side (AS) of a machine for processing printing substrates. On the operator side (BS) of the printing press 100 there may be a further linear drive of similar construction. Furthermore, FIG. 2 illustrates the comb-like structures of the respective winding cores of the primary parts AP1 and AP2 (double-comb principle). The two primary parts AP1 and AP2 and the guides 8 are received on an I-beam (double-T-beam) 10, which may be arranged on a beam 11 of a side wall 12 of the machine 100 for processing printing substrates.

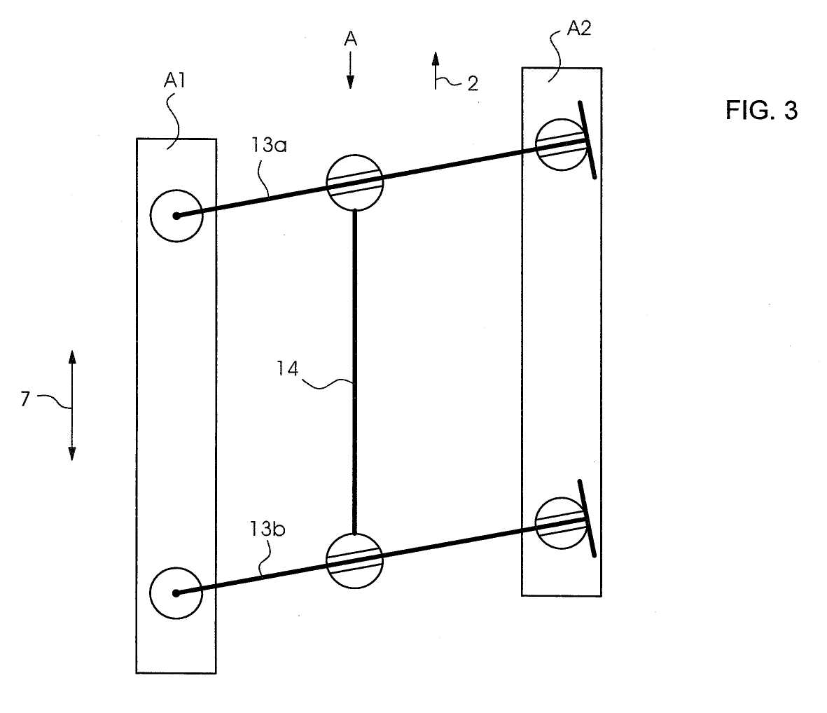

FIG. 3 illustrates the first carriage A1 and the second carriage A2 of the first linear drive A. The two carriages are mechanically coupled by two parallel rockers 13a and 13b, which are preferably arranged on the top or bottom side of the carriages. A modification of the relative position 7 of the two carriages with respect to each other in the direction of transport 2 causes the parallel rockers 13a and 13b to rotate. These two parallel rockers support a rotary slide 14, which may in turn support the gripper bar 6. The guides of the rotary slide (for example on the drive side AS) are preferably secured to the parallel rockers by a clamping force. The parallel rockers are additionally capable of implementing a longitudinal compensation in the case of a relative movement of two carriages of a carriage pair.

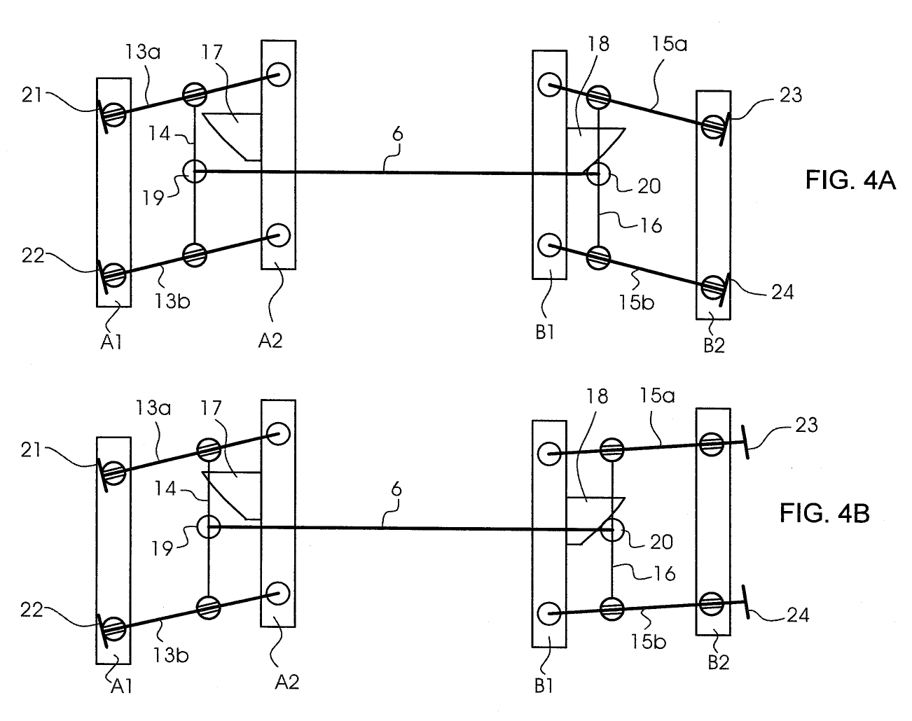

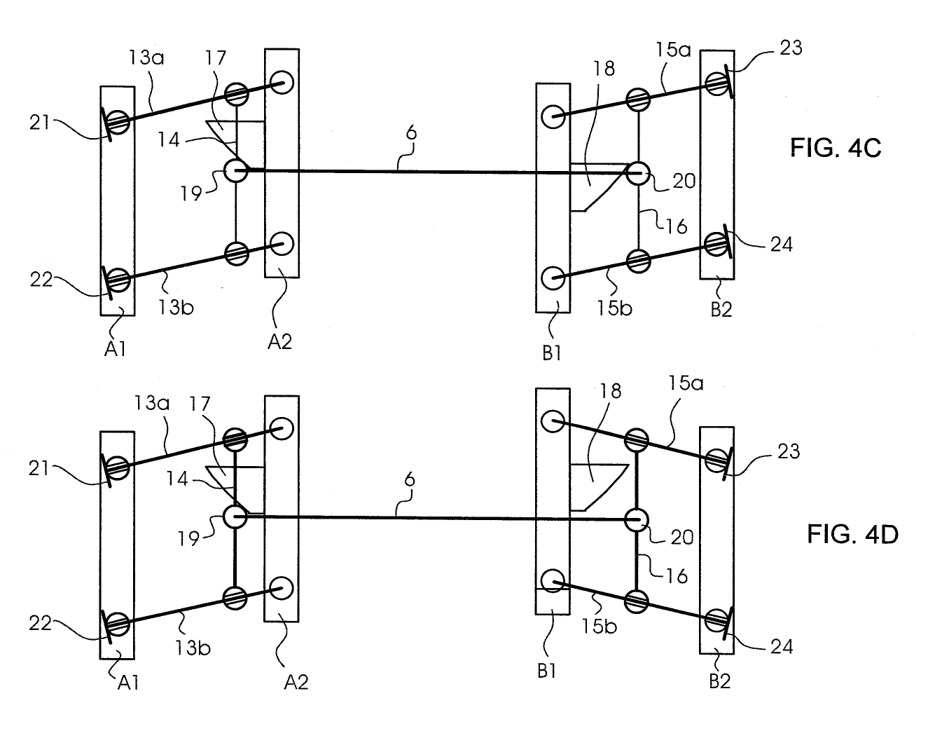

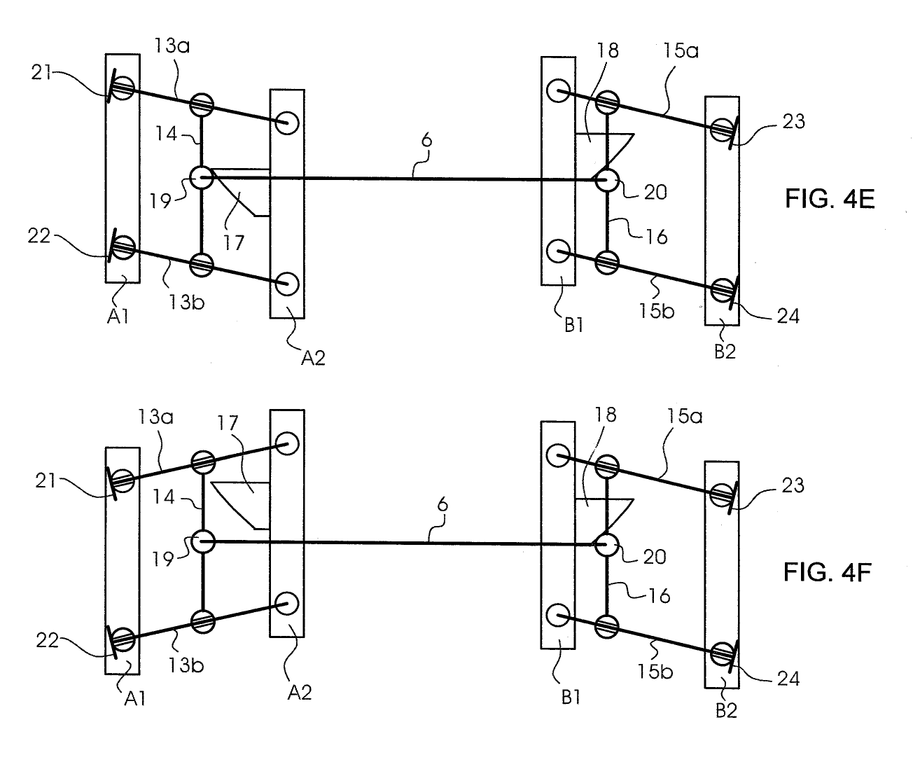

The functioning of the linear drive system according to the invention will be explained below and is illustrated in FIGS. 4A to 4F. As shown in FIG. 4, two carriages (A1, A2 and B1, B2) are preferably provided on each side of the printing substrate and are mechanically coupled to each other by the gripper bar 6 or a suitable crossbar. Each of the two carriage pairs has two parallel rockers (13a, 13b and 15a, 15b) and a rotary slide (14 and 16). Moreover, a respective cam 17, 18 is provided on carriage A2 and carriage B1. Each of the cams 17, 18 cooperates with a cam follower 19, 20 of the respective rotary slide 14, 16. All lateral adjusting movements are made against a clamping force of the rotary slide.

FIG. 4A illustrates the initial position in which the gripper bar 6 is oriented to one side to a maximum extent (in FIG. 4A, the gripper bar is oriented towards the left side; in the machine, this may, for example, be the operator side BS). The two carriages B1 and B2 are offset with respect to each other. Cam follower 20 is in contact with cam 18, so that a relative movement between the two carriages B1 and B2 causes cam follower 20 to roll on cam 18 and thus rotary slide 16 and gripper bar 6 to move in the lateral direction. In the situation illustrated in FIG. 4A, one carriage on each side of the printing substrate (A1 and B2) may be operated in the passive or active drag mode.

The stops 21 to 24 of the parallel rockers 13a, 13b and 15a, 15b show that in FIG. 4A, carriages A1 and B2 are in the drag mode, i.e. they are being dragged by their associated carriages A2 and B1. This situation has changed in FIGS. 4b and 4c: in these figures, only carriage A1 is in the drag mode.

FIG. 4B illustrates the effect of a relative movement between the two carriages B1 and B2 on a correction of the lateral register via an interaction between cam follower 20 and cam 18. The gripper bar 6 and thus the printing substrate 1 guided by the gripper bar 6 is moved in the lateral direction (to the right side in the Figure, in the machine to the drive side AS, for example). The result is the initiation of a lateral adjustment of the gripper bar and thus a correction of the lateral position of the conveyed printing substrate 1. The relative movement between the two carriages B1 and B2 may be caused by a movement of only one of the carriages or by a movement of both carriages.

FIG. 4C illustrates the situation at the end of the lateral adjustment. The two carriages B1 and B2 have been moved relative to each other with respect to their relative position illustrated in FIG. 4A, thus having caused a maximum movement of cam follower 20 in the lateral direction.

FIG. 4D now illustrates that a relative movement between carriages B1 and B2 can be used to return the carriage B2 to the drag mode without influencing the lateral position of the gripper bar 6. Thus in this situation again, two carriages, namely carriage A1 and carriage B2, are in the drag mode.

FIG. 4E illustrates the initiation of a relative movement between the two carriages A1 and A2. This relative movement causes cam follower 19 to roll on cam 17 and thus a change of the lateral position of rotary slide 14, of the gripper bar 6, and finally of the printing substrate 1. Again, the modification of the relative position between the two carriages A1 and A2 can be caused by a movement of only one of the two carriages or of both carriages. In the situation illustrated in FIG. 4E, carriage B2 continues to be in the drag mode.

FIG. 4F illustrates the end of the lateral repositioning of the gripper bar and of the correction of the lateral position of the gripper bar. Carriage A1 has been returned to the drag mode by a modification of its relative position with respect to carriage A2. The gripper bar 6 and the printing substrate 1 are now being transported in the direction of transport 2 in a laterally aligned position. Only carriages A2 and B1 drive the advancement of the gripper bar and the printing substrate.

For reasons of clarity, the maximum lateral adjustment was shown in FIGS. 4a to 4f. Of course, other lateral adjustments of a lesser degree are possible instead. For the correction of the lateral register, the lateral adjustment will only be carried out until the lateral position of the printing substrate 1 is in register.

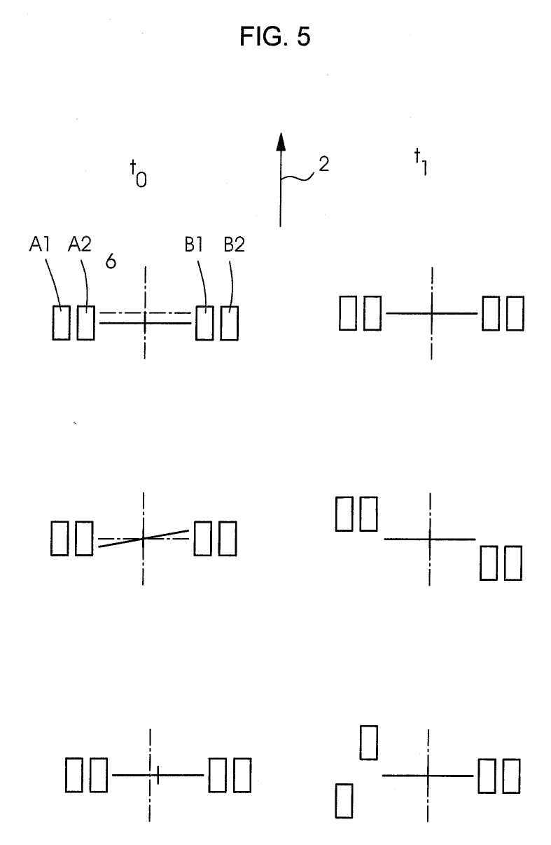

FIG. 5 illustrates that the carriages that are movable relative to each other as part of the linear drive system of the invention provide different adjustment options. At the top of FIG. 5, the position of the gripper bar 6 at an instant to is shown. At this instant, the gripper bar 6 is outside the register as viewed in the direction of transport 2 (i.e. outside what is known as the circumferential register). The desired in-register positioning of the gripper bar 6 is shown by the dashed lines in FIG. 5. At an instant t₁, also shown at the top of FIG. 5, the gripper bar has been aligned so as to be in register. The adjustment of the circumferential register has been achieved by moving all carriages A1, A2 and B1, B2 in the direction of transport 2. A relative movement between the carriages did not take place. Some of the carriages, for instance A1 and B2, may preferably be in the drag mode.

At the center of FIG. 5, the gripper bar 6 is illustrated at an instant to at which it is at a certain angle with respect to its desired in-register position. At a later instant t₁, the position of the gripper bar 6 has been corrected in terms of the diagonal register. This was achieved by a relative movement between the two carriage pairs A1, A2 and B1, B2 until a desired alignment of the gripper bar 6 was attained. In this respect, a relative movement between the carriages of a carriage pair did not take place. Some of the carriages, for instance carriages A1 and B2, may preferably be in the drag mode.

At the bottom of FIG. 5, a gripper bar 6 is illustrated at an instant to at which it is laterally offset relative to its desired in-register position and thus out of the lateral register. At a later instant t₁, the lateral position of the gripper bar 6 has been corrected so that the gripper bar 6 is in register. This was achieved by a relative movement between carriages A1 and A2. Carriages B1 and B2 did not carry out a relative movement.

The three situations shown in FIG. 5 illustrate that the device of the invention or a linear drive or linear drive system equipped in accordance with the invention can be used to carry out all necessary adjustments of a gripper bar and thus of a printing substrate that is being conveyed by the gripper bar in order to correct the different register positions of the printing substrate, i.e. to correct the position of the substrate in three degrees of freedom. Lateral displacement in particular and thus lateral register correction is possible as a result of a relative movement between two carriages of a carriage pair. The different registers can be controlled (with or without closed-loop control) successively or simultaneously by superimposed correcting movements of the carriages.

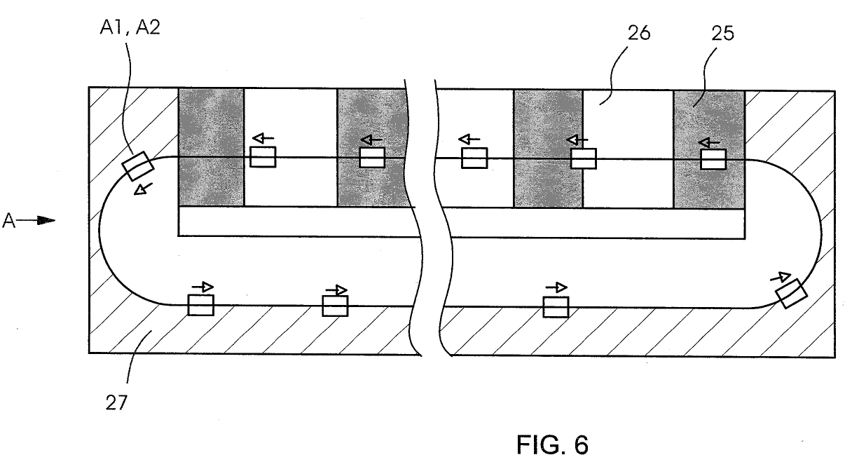

FIG. 6 illustrates a linear drive A with associated carriages A1, A2. As shown in FIG. 6, the linear drive preferably forms a closed path. Preferably, the carriages pass through sections illustrated in grey, in which one or more carriages may be in the active drag mode, and sections illustrated in white, in which alignment movements, for example lateral register corrections, of the carriages may be carried out. The preferred mode for the shaded section (on the return path) is the passive drag mode. A linear drive A of this type may be provided on the side wall of the machine for processing printing substrates, with the alternating white and gray sections representing the processing sections, e.g. the path through printing units. A method according to the invention may therefore be distinguished by the fact that an alternation between active and passive drag mode and active alignment may occur in any desired succession.

1. A device for correcting a lateral position of a printing substrate held by a gripper bar and conveyed in a transport direction, the device comprising:
an electric linear drive having a primary part, a first secondary part configured as a first carriage and associated with said primary part, and a second secondary part configured as a second carriage;
said first carriage and said second carriage being commonly disposed on a same side of the printing substrate in a lateral direction; and
said first carriage and said second carriage being movable relative to one another in the transport direction to correct a position of the printing substrate in the lateral direction.

2. The device according to claim 1, which comprises a link mechanically coupling said first carriage and said second carriage to one another.

3. The device according to claim 1, wherein said first carriage and said second carriage are separately controllable.

4. The device according to claim 1, wherein, in a first mode of operation, said first carriage and said second carriage jointly effect an advancement of the gripper bar.

5. The device according to claim 4, wherein, in a second mode of operation, only one of said first carriage and said second carriage effects an advancement of the gripper bar.

6. The device according to claim 1, wherein, in a second mode of operation, only one of said first carriage and said second carriage effects an advancement of the gripper bar.

7. The device according to claim 5, wherein the second mode of operation is selected from a passive drag mode or an active drag mode.

8. The device according to claim 1, wherein said primary part of said electric linear drive is a first primary part, said electric linear drive further includes a second primary part, and said second carriage is associated with said second primary part.

9. The device according to claim 8, wherein said first primary part and said second primary part of said electric linear drive are commonly disposed on a same side of the printing substrate in the lateral direction.

10. A machine for processing printing substrates, comprising a device according to claim 1.

11. The machine according to claim 10, configured as a printing press.

12. The machine according to claim 11, wherein the printing press is a sheet-fed rotary printing press for lithographic offset printing.

13. The machine according to claim 10, configured as a machine for processing printed product.

14. The machine according to claim 13, wherein the machine for processing printed product is a sheet-fed die-cutting machine.

15. A method of correcting a lateral position of a printing substrate being conveyed in a transport direction, which comprises:
providing an electric linear drive with two carriages commonly arranged on a common side of the printing substrate in a lateral direction relative to the transport direction; and
carrying out a relative movement between the two carriages of the electric linear drive for correcting the lateral position of the printing substrate.
